(19) United States
(12) Patent Application Publication
(10) Pub. No.: US 2019/0114470 A1
(43) Pub. Date: Apr. 18, 2019

(54) Method and System for Face Recognition Based on Online Learning

(71) Applicant: GORILLA TECHNOLOGY INC., Taipei City (TW)

(72) Inventors: SZE-YAO NI, Taipei City (TW); YUANG-TZONG LAN, Taipei City (TW)

(21) Appl. No.: 15/880,552

(22) Filed: Jan. 26, 2018

(30) Foreign Application Priority Data
Oct. 18, 2017 (TW) 106135640

(51) Int. Cl. G06K 9/00; G06K 9/66; G06K 9/62

(52) U.S. Cl. CPC G06K 9/00288; G06K 9/00255; G06K 9/00275; G06K 9/6215; G06K 9/66

(57) ABSTRACT

A method for face recognition based on online learning by calculating a similarity between each of the face images captured in a specific environment and a target face image so as to form a distribution of the similarities of the face images with respect to the target face image, wherein a similarity threshold with respect to the first target face image is determined according to a predefined rule and the distribution of the similarities, wherein the similarity threshold is used for subsequent selection of a face image captured in the specific environment and having a similarity greater than said similarity threshold with respect to the target face image.

### CROSS-REFERENCE TO RELATED APPLICATION

This application claims the Priority of Taiwan application No. 106135640 filed Oct. 18, 2017, the disclosure of which is incorporated herein in its entirety by reference.

### BACKGROUND OF THE INVENTION

### 1. Field of the Invention

The present invention relates to a face recognition method, and more particularly, to a face recognition method based on online learning.

### 2. Description of the Prior Art

The development of face recognition technology has been booming in recent years, especially after introduction of deep learning methods. Face recognition based on deep learning technology becomes more and more popular, such as access control, photo classification, etc. Although the face recognition technology has made great strides in recent years, it is still vulnerable to some factors such as ambient light sources, facial angles, etc., and the recognition rate can vary very much in different environments. For example, the current face recognition technology based on deep learning methods generally adopts the public face database on the internet, and most of the faces in the database are taken from Westerners, as a result, the recognition rate will be significantly dropped in certain applications in which Asian faces are the main targets for face recognition.

Furthermore, in reality, it is impractical to use a common threshold for filtering people with respect to a target person in all different environments because image quality can vary very much from environment to environment. For example, the face recognition system used for monitoring the attendance of people can allow a slightly higher error rate so as to reduce user inconvenience, however, if a face recognition system is used for access control, then only a low error rate is permissible so as to increase the security lever for achieving the purpose of safety surveillance.

In addition, when using an old photograph to searching for a particular person, such as a criminal, it is impractical to compare the face images of the people with the old photograph of the criminal for filtering people in different sites. Accordingly, a new method for face recognition is needed to solve the above problems.

### SUMMARY OF THE INVENTION

It is an object of the present invention to provide a method and system for face recognition based on online learning, which can be installed in different client sites, and the system for face recognition based on online learning can perform online learning using the face images taken from a specific environment of the client site for learning and reinforcing certain specific characteristics of images taken from said specific environment of the client site.

It is an object of the present invention to provide a method and system for face recognition based on online learning, which can be installed in many different environments to search for certain persons such as criminals by comparing face images of the people present in different environments with old photographs of the criminals, wherein in each environment, a corresponding similarity threshold with respect to each old photograph of the criminals can be respectively determined. Once a similarity threshold with respect to an old photograph of a criminal is determined for a particular environment, the similarity threshold can be used for identifying suspects present in that particular environment, wherein each suspect has a similarity greater than the similarity threshold with respect to the old photograph of the criminal.

In one embodiment of the present invention, there is provided a method for face recognition based on online learning, the method comprising: capturing face images, extracting characteristics in the face images, online learning and classifying the characteristics of the face images, and online learning for determining a similarity threshold with respect to a target face image.

In one embodiment of the present invention, there is provided a method for face recognition based on online learning, the method comprising: capturing a plurality of first face images in a specific environment; calculating a similarity between each of the first face images and a target face image so as to form a distribution of the similarities of the plurality of the first face images with respect to the target face image; and determining a similarity threshold with respect to the target face image according to a predefined rule and the distribution of the similarities of the plurality of first face images with respect to the target face image, wherein the similarity threshold is used for subsequent selection of a second face image captured in the specific environment, wherein the second face image has a similarity greater than the similarity threshold.

In one embodiment, the predefined rule is a predefined ratio, wherein in the distribution of the similarities of the plurality of first face images, the similarity corresponding to the total number of the plurality of first face images multiplied by the predefined ratio is determined as the similarity threshold. In one embodiment, the predefined rule is to calculate the similarity threshold according to mean and standard deviation of the distribution of the similarities of the plurality of first face images and an expected error rate.

In one embodiment, the similarity of each of the first face images is within a range such that the distribution of the similarities of the plurality of first face images does not include outlier samples.

In one embodiment, a plurality of target face images can be processed simultaneously, and each target face image can obtain a corresponding similarity threshold in the specific environment.

In one embodiment of the present invention, there is provided a face recognition system based on online learning, the system comprising: an image receiving module for receiving a plurality of first face images captured in a specific environment; an image recognition module for calculating the similarity between each of the first face images and each of the at least one target face image, respectively; and a statistical module, for forming a similarity distribution of the plurality of first face images with respect to each target face image, respectively, and determining the similarity threshold with respect to each target face image, respectively according to a predefined rule and each of the similarity distributions, for subsequent selection of a second face image captured in the specific environment, wherein the similarity of the second face image is greater than the similarity threshold of the target face image.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 illustrates a flowchart of a method for face recognition based on online learning according to one embodiment of the present invention;

FIG. 2 illustrates an online learning procedure for obtaining a facial characteristic classifier according to one embodiment of the present invention;

FIG. 3 illustrates a flowchart of online threshold learning procedure according to one embodiment of the present invention;

FIG. 4 illustrates a flowchart of a method for face recognition based on online learning according to one embodiment of the present invention;

FIG. 5 is a schematic illustrating a system for face recognition based on online learning according to one embodiment of the present invention; and

FIG. 6 is a diagram illustrating different similarity distributions with different similarity thresholds in one embodiment of the present invention.

### DESCRIPTION OF THE PREFERRED EMBODIMENT

The foregoing description of other aspects, features and effects of the present invention will be apparent from the following detailed description of the preferred embodiments with reference to the drawings. It is to be understood, however, that the following examples are not intended to limit the invention.

Different from offline deep learning by using a vast amount of data, the online learning mechanism can further perform an online learning so as to obtain a face classifier for a particular person, while using the face characteristics obtained through the offline learning. In one embodiment of the present invention, the facial characteristics can be first learned through deep learning methods using a vast amount of face images offline to learn ways to express facial characteristics. However, in practical applications, the facial characteristics are not limited to those learned by using deep learning methods, the facial characteristics can be learned by other conventional methods as well, which can be used in the present invention. In reality, the image quality may vary from environment to environment, it is difficult to use a common threshold for all different environments. Therefore, the present invention proposes an online learning mechanism to determine a threshold based on the similarity distribution of the face images taken from a particular environment and a predefined rule, such as an expected error rate, so that different environments may have different thresholds. The system can automatically learn the desired threshold for any particular environment based on the face images taken from that particular environment. Compared with the conventional techniques, the present invention can reduce the processing time of manually marking the face images by automatically calculating a desired threshold through statistics of the images that are taken from that particular environment.

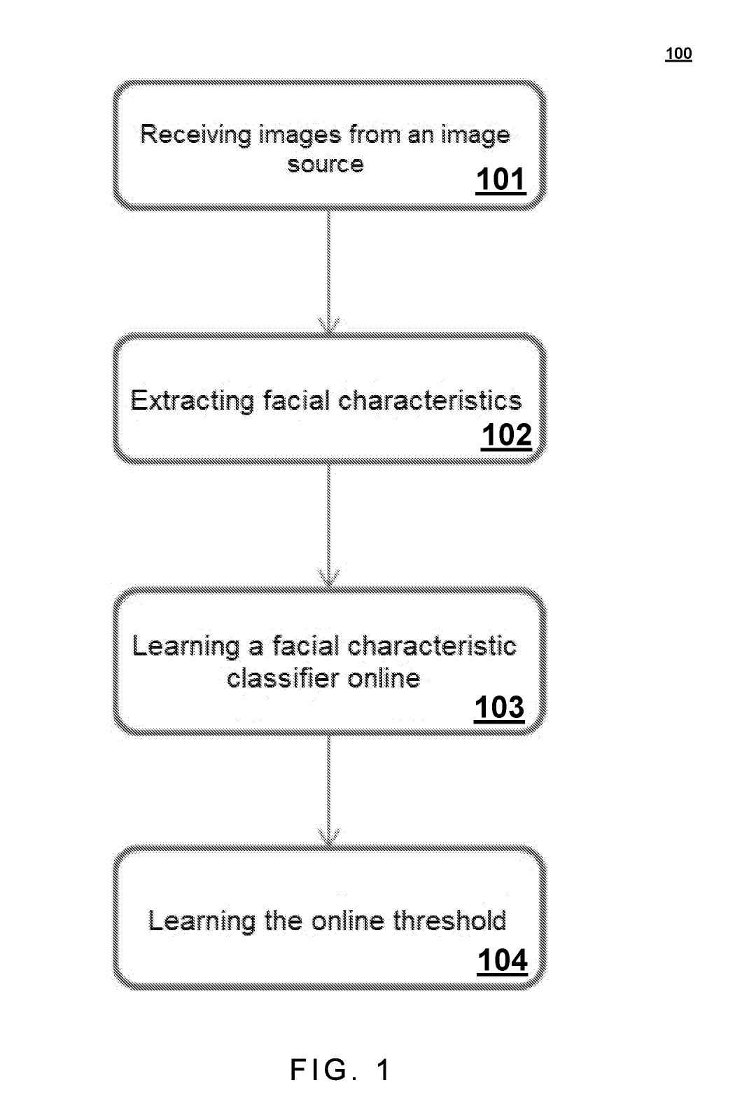

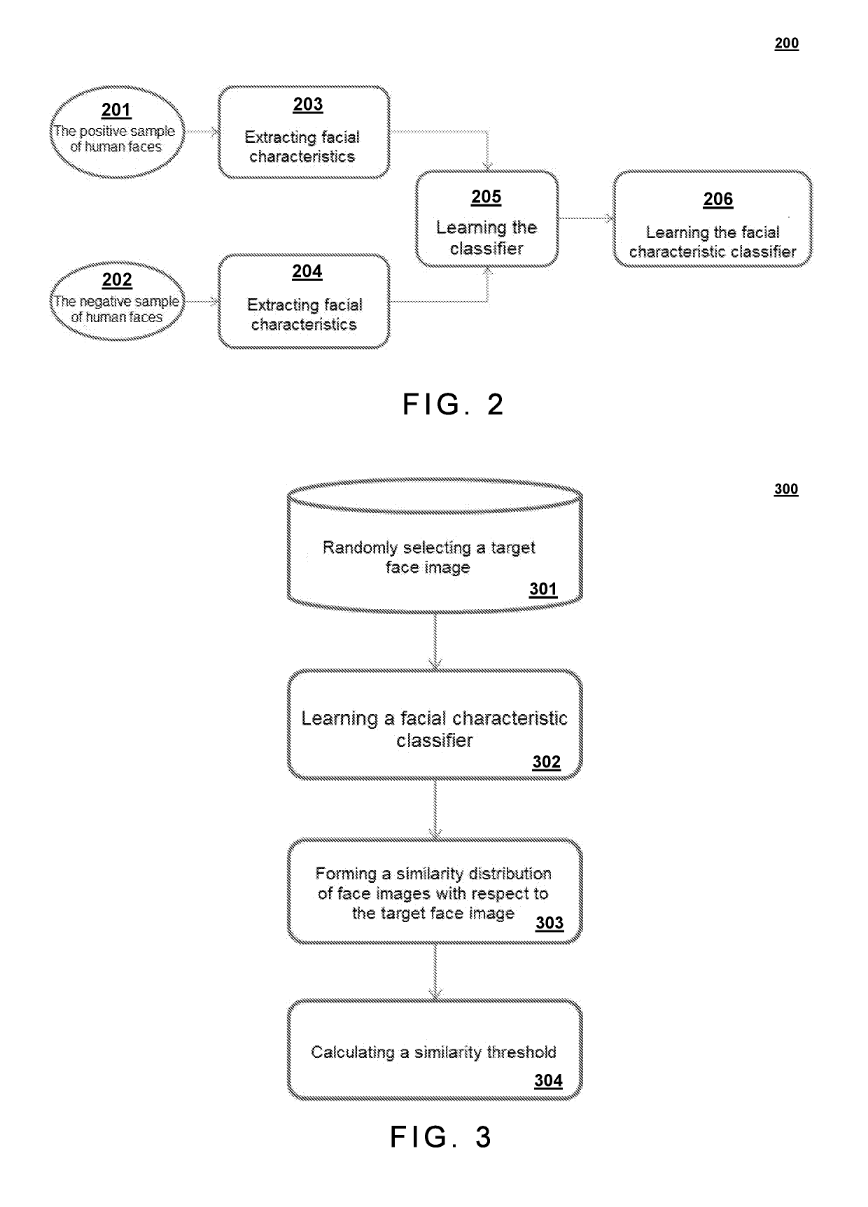

FIG. 1 illustrates a flowchart of a method for face recognition based on online learning according to one embodiment of the present invention. Please refer to FIG. 1. The method comprises the following steps. In step 101, receiving images from an image source and determining the position of the face, face angle and the positions of the five sense organs in each image through image pre-processing and necessary image analysis. In step 102, extracting facial characteristics by analyzing the information obtained from step 101 so as to convert a face image into facial characteristic vectors through some necessary pre-processing such as adjusting the position of the face in the face image. In this embodiment, the facial characteristics can be first learned through deep learning methods using a vast amount of face images offline. However, in practical applications, the facial characteristics are not limited to those learned through the deep learning methods, the facial characteristics can be also learned by other conventional methods. In Step 103, a facial characteristic classifier is learned online. A facial characteristic classifier is trained separately for each target person based on the facial characteristics obtained in the previous step 102. Please refer to FIG. 2 for a further understanding of the step 103. In step 104, the online threshold learning is conducted on the facial characteristic classifier obtained in the previous step 103 by comparing a large amount of face images with respect to a target face image to obtain a similarity distribution of the face images with respect to the target face image. The system then automatically calculates and determines the similarity threshold with respect to the target face image. Please refer to FIG. 3 for a further understanding of the 104.

Please refer to FIG. 2 which illustrates an online learning procedure for obtaining a facial characteristic classifier according to one embodiment of the present invention. Different from offline deep learning by using a vast amount of data, the online learning mechanism can further perform an online learning so as to obtain the facial characteristic classifier for a particular target face image, in addition to using the face characteristics obtained through the offline learning. The online learning procedure for obtaining a facial characteristic classifier is as follows. First, the characteristics of each face image are obtained. Next, for each target face image, the characteristics obtained from the target face image are taken as positive samples 201. The characteristics obtained from all other face images are taken as negative samples 202. Then, extracting facial characteristics 203 of the positive samples 201 and the facial characteristics 204 of the negative samples 202 for learning the facial characteristic classifier 206. In order to increase the diversity of the negative samples 202, a large number of different face images randomly selected from a database may be added to the negative samples 202 for learning the facial characteristic classifier 206. In the meantime, in order to avoid excessive disparities in the ratio of the number of positive samples to the number of negative samples, the diversity of the positive samples 201 can be increased by increasing the weight of positive samples or through some image augmentation methods on the positive samples 201, such as by mirroring, rotating, displacing and contrast changing of the positive samples 201.

FIG. 3 illustrates a flowchart of online threshold learning procedure according to one embodiment of the present invention. As shown in FIG. 3, in step 301, a target face image is randomly selected; in step 302, a facial characteristic classifier is learned; in step 303, a similarity distribution of face images with respect to the target face image is formed; and in step 304, a similarity threshold is calculated according to the similarity distribution of the face images with respect to the target face image. In practical applications, it is difficult to use a common threshold for all different environments because image quality may vary very much from environment to environment. The calculation of a personalized similarity threshold can overcome the issue. At the same time, an appropriate similarity threshold can be respectively calculated according to each different environment, for example, the administrator can set an expected error rate, and the system can automatically calculate an appropriate similarity threshold according to the face images taken from a particular environment. The calculation method is as follows. First, given face images of a target person, extracting facial characteristics of the face images of the target person so that the facial characteristic classifier of the target person can be obtained through learning of the facial characteristics in the face images of the target person. A similarity comparison is performed between all other people's face images and the facial characteristic classifier of the target person to obtain the distribution of similarity of all other people's face images with respect to the target person. The statistics of all similarity are calculated, including the mean and standard deviation. If other people's face images are randomly selected and the number of the face images is sufficient, the similarity distribution with respect to the target person will be a Gaussian distribution (or Normal distribution). By means of statistics, mean and standard deviation of the similarity distributions can be obtained. An appropriate similarity threshold is calculated from the mean and standard deviation of the similarity distributions and the expected error rate set by the administrator. A personalized similarity threshold of each target person can be respectively calculated through this method. By setting such a personalized similarity threshold, the issue where other people are easily mistaken for the target person can be solved while maintaining a reasonable accuracy.

In practical applications, in order to achieve maximum automation and to reduce manual work, the online similarity threshold learning proposed by the present invention automatic selects images of other people with respect to a target person for calculating the similarity distribution without human supervision. In order to avoid face images of the target person from being added to the samples for calculating the similarity distribution, the similarity of each of the face images for calculating the similarity distribution is controlled within a range so that the similarity distribution can be obtained without human intervention by automatically excluding outlier samples outside said range. Please note that the present invention is not limited to the unsupervised mode. In practical applications, supervised mode may also be adopted to increase the accuracy of the similarity distribution, for example, face images can be manually marked in advance, and then the similarity threshold can be calculated automatically through the method described above.

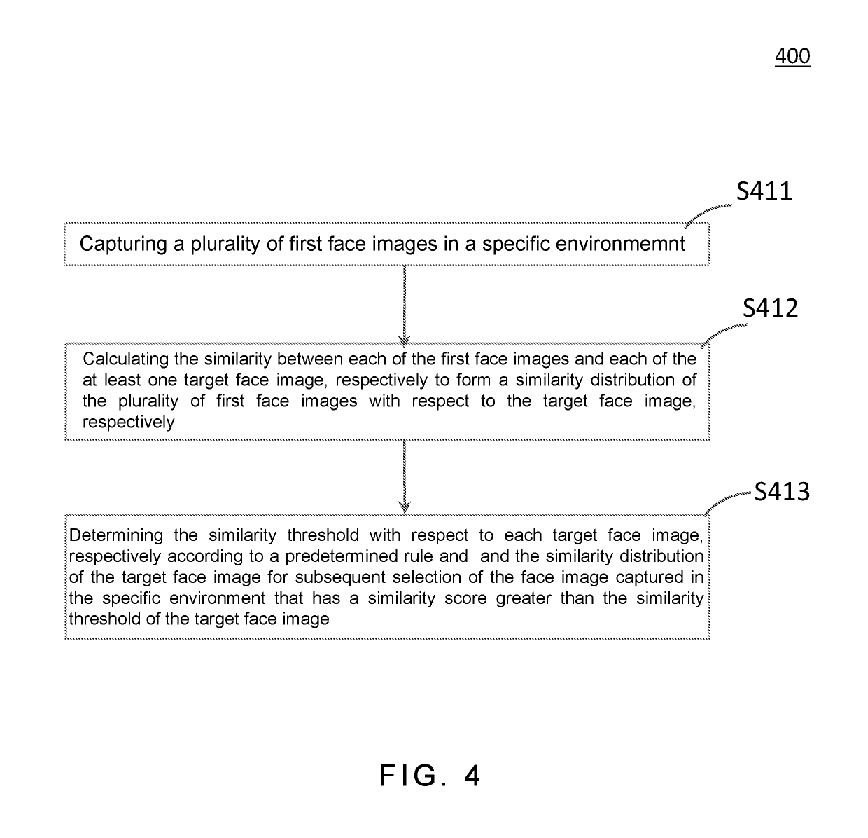

FIG. 4 illustrates a flowchart of a method for face recognition based on online learning according to one embodiment of the present invention. Please refer to FIG. 4. The method for face recognition based on online learning comprises the following steps: in step S411, capturing a plurality of first face images in a specific environment; in step S412, calculating the similarity between each of the first face images and each of the at least one target face image, respectively to form a similarity distribution of the plurality of first face images with respect to the target face image, respectively; and in step S413, determining the similarity threshold with respect to each target face image according to a predefined rule and the similarity distributions of the target face image, respectively for subsequent selection of the face image captured in the specific environment that has a similarity greater than the similarity threshold.

In one embodiment, the predefined rule comprises a predefined ratio, wherein the similarity threshold with respect to the target face image is determined as the similarity corresponding to the total number of the plurality of first face images multiplied by the predefined ratio. In one embodiment, the similarity threshold with respect to the target face image is determined according to the mean and standard deviation of the distribution of the similarities of the plurality of first face images with respect to the target face image and an expected error rate.

In one embodiment, the similarity of each of the first face images is within a range such that the similarity distribution does not include outlier samples.

In one embodiment, a plurality of target face images can be processed simultaneously, and each target face image can have a corresponding similarity threshold in a specific environment.

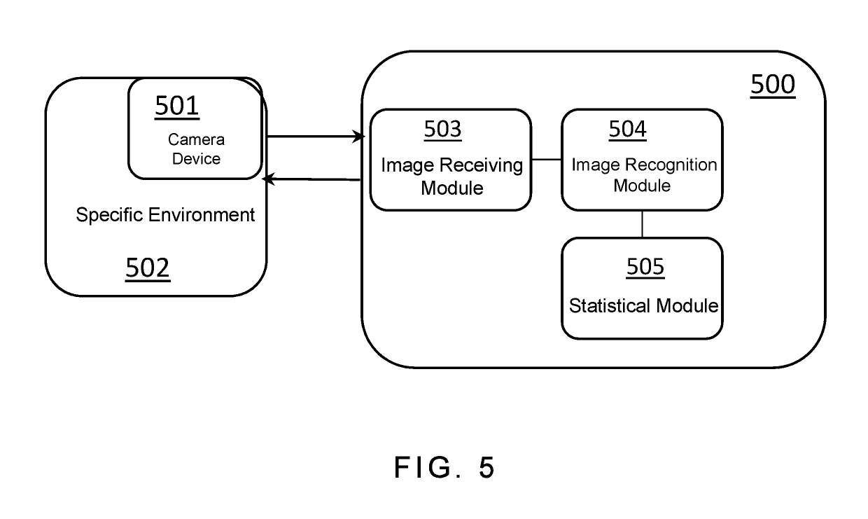

FIG. 5 is a diagram illustrating a system for face recognition based on online learning 500 according to one embodiment of the present invention. Please refer to FIG. 5. The system for face recognition based on online learning 500 comprises an image receiving module 503 to receive a plurality of first face images captured by a camera device 501 in a specific environment 502; an image recognition module 504 to calculate the similarity between each of the first face images and each of the at least one target face image, respectively; and a statistical module 505 to respectively form a similarity distribution of the plurality of first face images with respect to each of the target face image, and determining a corresponding threshold with respect to each target face image, respectively, according to a predefined rule and the similarity distribution of the target face image. In one embodiment, the predefined rule comprises a predefined ratio, wherein the similarity threshold with respect to the target face image is determined as the similarity corresponding to the total number of the plurality of first face images multiplied by the predefined ratio. In one embodiment, the similarity threshold with respect to the target face image is determined according to the mean and standard deviation of the distribution of the similarities of the plurality of first face images with respect to the target face image and an expected error rate. Each of the above-mentioned image receiving module 503, image recognition module 504 and statistical module 505 may comprise software, hardware, or a combination of hardware and software to achieve its functions.

In one embodiment, the similarity of each of the first face images is within a range such that the similarity distribution does not include outlier samples.

In one embodiment, a plurality of target face images may be processed simultaneously, wherein each target face image can have a corresponding similarity threshold in the specific environment.

The method and the system for face recognition based on online learning of the present invention can be used for identifying suspects in different environments with respect to an old face image of a targeted criminal, wherein in each environment, a corresponding similarity threshold with respect to the old face image of the targeted criminal can be respectively determined since the image quality can be different from environment to environment. Once the similarity threshold with respect to the old face image of the targeted criminal is determined for a particular environment, the similarity threshold can be used for identifying suspects present in that particular environment, wherein each suspect has a similarity greater than said similarity threshold.

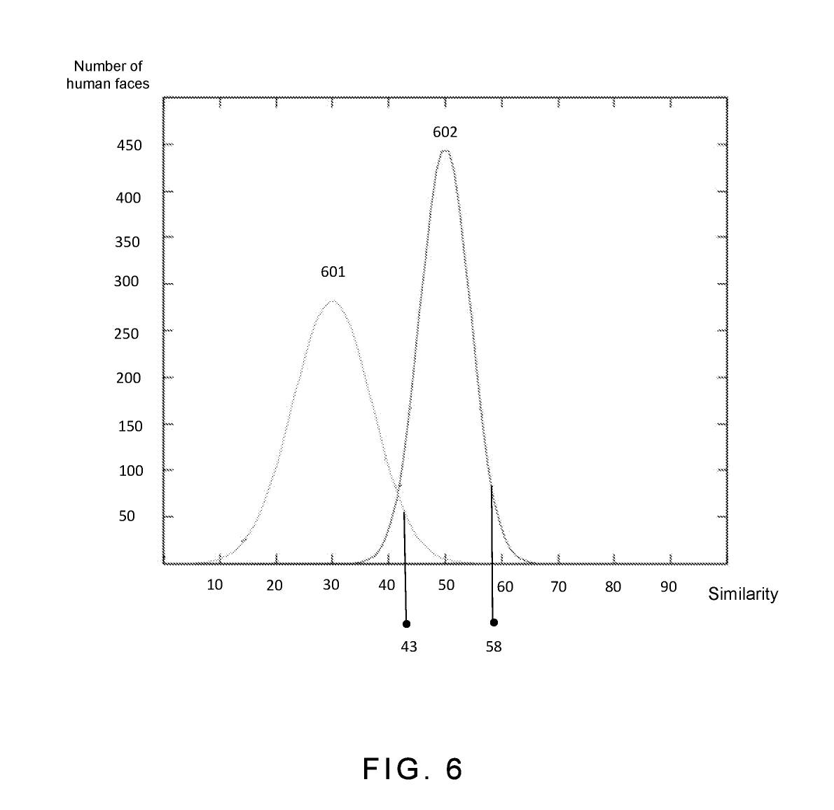

FIG. 6 is a diagram illustrating different similarity distributions with different similarity thresholds. Please refer to FIG. 6. The similarity distribution of face images captured in different environments will be different. The similarity distribution 601 and the similarity distribution 602 in FIG. 6 are different since face images are taken from different environments. According to a predefined rule, the similarity threshold 601 of the similarity distribution is 43, and the similarity threshold of the similarity distribution 602 is 58.

As described above, an advantage of the present invention is to provide a face recognition method and system based on online learning. In practical applications, the existing face image data of the client can be used for online learning after the face recognition system is installed on a client end. Specific types of characteristics for specific environments and image types by means of online learning can be learned and enhanced. At the same time, the online threshold learning mechanism of the present invention can be used in many different environments, and the system of the present invention can automatically determine a similarity threshold in any particular environment according to a predefined rule. After the similarity threshold is determined, the similarity threshold can be used for subsequent selection of face images captured in that particular environment and each having a similarity greater than the similarity threshold of the target face image.

What is claimed is:

1. A method for face recognition based on online learning, comprising:
capturing a plurality of first face images in a specific environment;
calculating a similarity between each of the first face images and a first target face image so as to form a distribution of the similarities of the plurality of first face images with respect to the first target face image; and
determining a similarity threshold with respect to the first target face image according to a predefined rule and the distribution of the similarities of the plurality of first face images with respect to the first target face image, wherein the similarity threshold is capable of being used for subsequent selection of a second face image captured in the specific environment, wherein the second face image has a similarity greater than said similarity threshold with respect to the first target face image.

2. The method according to claim 1, wherein the predefined rule comprises a predefined ratio, wherein the similarity threshold with respect to the target face image is determined as the similarity corresponding to the total number of the plurality of first face images multiplied by the predefined ratio.

3. The method according to claim 1, wherein the similarity threshold with respect to the target face image is determined according to an expected error rate and the mean and standard deviation of the distribution of the similarities of the plurality of first face images with respect to the target face image.

4. The method according to claim 1, wherein the similarity of each of the first face images is within a range such that the distribution of the similarities does not include outlier samples.

5. The method according to claim 1, wherein multiple target face images are capable of being processed concurrently, wherein a corresponding similarity threshold is determined for each of the multiple target face images.

6. A system for face recognition based on online learning, comprising:
an image receiving module, for receiving a plurality of first face images captured in a specific environment;
an image recognition module, for calculating the similarity between each of the first face images and the first target face image; and
a statistical module, for forming a distribution of the similarities of the plurality of first face images with respect to the first target face image and determining a similarity threshold with respect to the first target face image according to a predefined rule and the distribution of the similarities of the plurality of first face images with respect to the first target face image, wherein the similarity threshold is capable being used for subsequent selection of a second face image captured in the specific environment, wherein the second face image has a similarity greater than said similarity threshold with respect to the first target face image.

7. The system according to claim 6, wherein multiple target face images are capable of being processed concurrently, wherein a corresponding similarity threshold is determined for each of the multiple target face images.

8. The system according to claim 6, wherein the predefined rule comprises a predefined ratio, wherein the similarity threshold with respect to the target face image is determined as the similarity corresponding to the total number of the plurality of first face images multiplied by the predefined ratio.

9. The system according to claim 6, wherein the similarity threshold with respect to the target face image is determined according to an expected error rate and the mean and standard deviation of the distribution of the similarities of the plurality of first face images with respect to the target face image.

10. The system as according to claim 6, wherein the similarity of each of the first face images is within a range such that the distribution of the similarities does not include outlier samples.
